(19) United States
(12) Patent Application Publication
(10) Pub. No.: US 2010/0285259 A1
(43) Pub. Date: Nov. 11, 2010

(54) REINFORCED SELF ADHERING CONSTRUCTION TAPE

(76) Inventor: Matthew Bullock, McLean, VA (US)

Correspondence Address: KILE PARK REED & MCMANUS, 1200 NEW HAMPSHIRE AVE, NW, SUITE 570, WASHINGTON, DC, 20036, US

(21) Appl. No.: 12/463,143

(22) Filed: May 8, 2009

(51) Int. Cl. B32B 33/00

(52) U.S. Cl. 428/41.8

(57) ABSTRACT

A laminated construction tape for use as balcony flashing tape, flashing for roofing joints, foundation flashing, step flashing under siding, balcony and breezeway flashing, and the like, the laminated construction tape includes a flexible, spun bonded polyester strip and a first layer of adhesive longitudinally extending along and covering a central strip of the spun bonded strip. A layer of reinforcing polyester yarns is bonded to the spun boned strip by the first layer of adhesive. A second layer of adhesive is applied to the spun bonded strip and is coextensive with the strip and covers the layer of reinforcing as well as the edges of the spun bonded strip on each side of the band of polyester yarns which have a combined width of approximately greater than twenty five percent and less than fifty percent of the overall width of the construction tape. A release strip is applied over the second layer of adhesive and is removable for application of the laminated construction tape to a building junction site.

### BACKGROUND OF THE INVENTION

This invention relates to an improved reinforced, self-adhering, construction tape. More particularly, this invention relates to a novel, construction tape that has application in the construction industry such as for balcony flashing tape, flashing for roofing joints, foundation flashing, step flashing under siding, balcony and breezeway flashing, and the like.

In the building construction industry, such as for example residential homes, maintaining water proof integrity of the structure at junction locations is essential. In this a construction junction naturally exists around balcony additions, foundation transitions, chimney and skylight junctions, roof transitions, and the like. Each of these junction areas must be water proof and free from flowing and capillary water invasion from external sources.

In the past junction or transition locations have been covered with metal flashing and sealed around the edges by elastomeric calking. Alternatively, or in addition, transition junctions have been sealed by application of a liquid sealant which can be rolled or sprayed over a joint and allowed to set into a firm water resistant film.

Another system employed in the past involves the application of successive layers of felt paper and application of hot bitumen composition that is used to coat and seals joints.

In still a further previously know system a spun bonded polyester strip was provided with longitudinal reinforcing and self adhering adhesive which has been applied in widths of four to as much as eight or more inches over joints, cracks and flashing junctions to maintain water integrity of a construction structure. Although such tapes exhibit enhanced utility it has been determined that further improvement is possible with respect to edge sealing integrity and reinforcing width as well as specific component details of an overall enhanced construction tape. In this a degree of edge or border flexibility for permitting some structural creep or movement without interfering with a watertight edge seal while maintaining a central core strength of the tape would be highly desirable. Moreover enhanced component detail has been envisioned for specific operative combinations of components.

Although previously known systems are operative they exhibit limitations such as difficulty of application and reliability of performance. Moreover cracking and structural shifting of building joints renders some prior systems inoperative and in need of maintenance and/or replacement repair.

In view of the above and other limitations, a need exists for sealing junction transitions of building joints that is easy to install and reliable in performance over an extended period of time.

The problems suggested in the preceding are not intended to be exhaustive but rather are among many which may tend to reduce the effectiveness of prior water barrier systems for building junctions Other noteworthy problems may also exist; however, those presented above should be sufficient to demonstrate that waterproofing construction junctions appearing in the past will admit to worthwhile improvement.

### SUMMARY OF THE INVENTION

One embodiment of the invention comprises a laminated construction tape for use as balcony flashing tape, flashing for roofing joints, foundation flashing, step flashing under siding, and the like. The laminated construction tape includes a flexible, spun bonded polyester strip and a first layer of adhesive longitudinally extending along and covering a central strip of the spun bonded strip. A layer of reinforcing polyester yarns is bonded to the spun boned strip by the first layer of adhesive. A second of adhesive is applied to the spun bonded strip and is coextensive with the strip and covers the layer of reinforcing as well as the lateral edges of the spun bonded strip on each side of the band of polyester yarns. In order to provide enhanced adhesion in combination with core strength it has been determined that the sum of the width of lateral edges running along the spun bonded strip is greater than twenty five percent (25%) and less than fifty percent (50%) of the width of the spun bonded strip. A release strip is applied over the second layer of adhesive and is removable for application of the laminated construction tape to a building junction site.

### THE DRAWINGS

Other aspects of the present invention will become apparent from the following detailed description of embodiments taken in conjunction with the accompanying drawings wherein:

FIG. 1 is a view of a generic house with numerous applications for flashing around balcony junctions, roofing joints, foundation junctions, siding junctions, breezeway flashing, chimney junctions, roofing edge junctions and the like;

FIG. 2 is an axonometric view, partially broken away, disclosing use of the subject invention at a deck junction and a sidewall of a home building;

FIG. 3 is an axonometric view of application of the subject invention at a foundation junction of a home building;

FIG. 4 is a partially broken away view disclosing use of the invention as flashing a joining sections of a roof for a home;

FIG. 5 is a partially broken away view showing use of the subject construction flashing around a junction of a chimney and a roof line;

FIG. 6 is an axonometric view of a roll of construction tape in accordance with the invention partially broken away to disclose details of various layers of the subject construction tape; and

FIG. 7 is a cross-sectional view, taken along section line 7-7 in FIG. 6 and disclosures internal structural details of the subject construction tape.

### DETAILED DESCRIPTION

### Context of the Invention

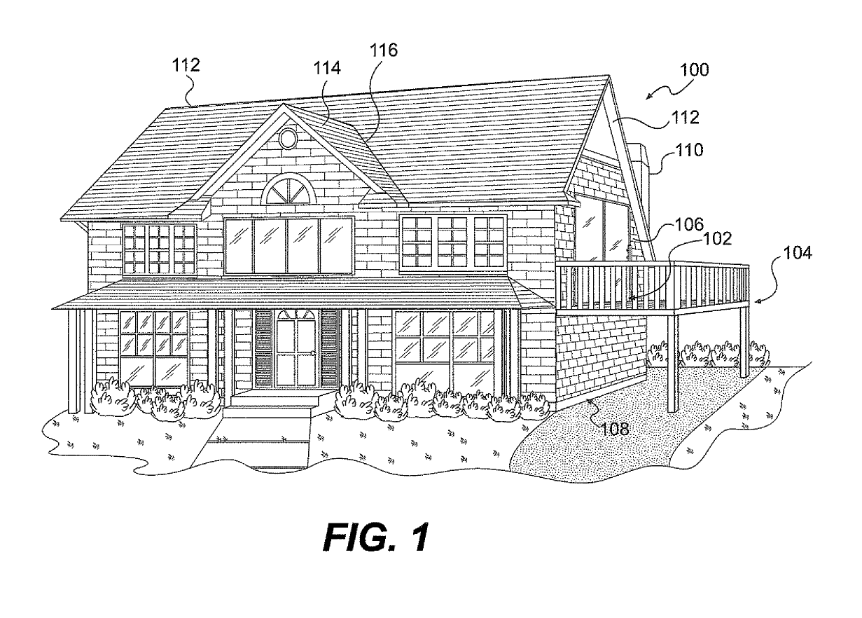

Turning now to the drawing where like numerals indicate like parts, FIG. 1 shows an axonometric view of a residential home 100 as an illustrative operative context of the invention. In this the home includes numerous construction junction locations such as for example the junction 102 between a generally horizontal elevated deck 104 and a sidewall 106 of the home. In a similar vein a construction junction exists between the side 106 of the home and a base foundation as at 108. The home includes a chimney 110 that projects though a roof 112 and architectural roofing design creates sloping junctions 116. At each of the noted construction junction sites, and others, there is a need to prevent water and moisture from migrating and penetrating into the home through the joint.

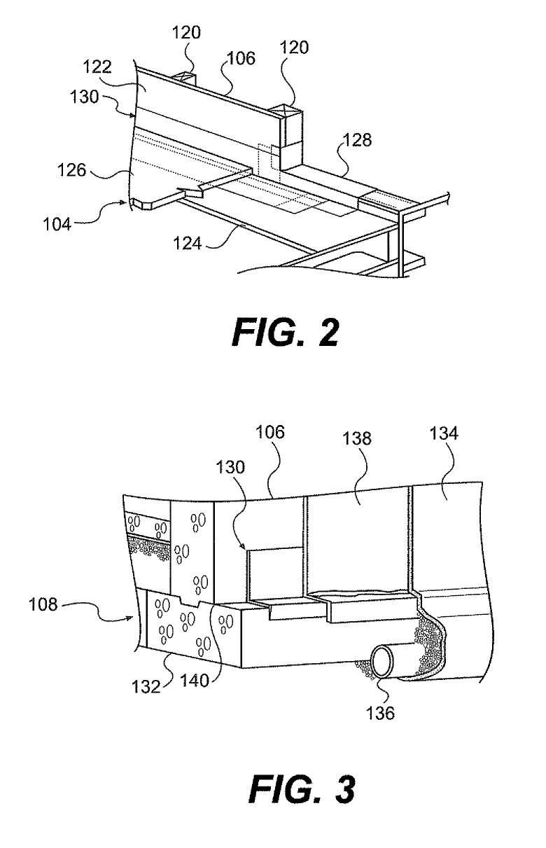

Turning now to FIG. 2 there will be seen a broken away partial section of the side wall 106 including interior studs 120 and siding 122 nailed or otherwise mounted on the studs. An exterior deck 104 is shown constructed with a subflooring 124 affixed to generally horizontal joists and an overlaying top layer of decking 126. Metal flashing 128 is shown positioned around a doorway and a laminated construction tape 130, in accordance with the invention, is shown positioned, in one form of application of the invention, between the sub flooring 124 and the side wall 122 of the home.

FIG. 3 shows another, illustrative, operational context of the invention at a foundation junction 108. In this context a side wall 106 is shown meeting footer 132. Sidewall sheeting 134 extends along the side wall 106 around and over a drain pipe system 136 to drain water away from the foundation. A metal flashing 138 can be installed along the foundation to isolate a junction line 140 in the foundation from water and moisture penetration. In addition a laminated construction tape 130 can be economically installed to provide the primary or additional protection from water seepage into the foundation junction as shown.

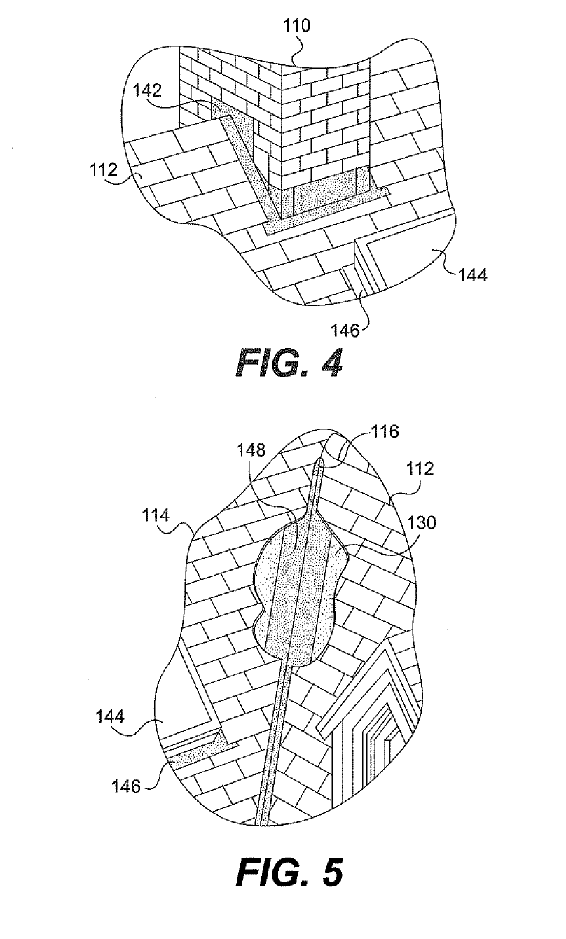

FIG. 4 illustrates another operative context of the invention and in this a chimney 110 projects through the roof 112 of a home and a combination of metal flashing 142 and interior mounted laminated construction tape in accordance with the invention is used to isolate the interior of the home from water seepage. In a similar manner FIG. 4 also discloses a skylight 144 positioned through a hole cut in the roof 112. Laminated construction tape, in accordance with the invention, is used in combination with metal flashing 146 to prevent water from entering the home around the skylight 144.

Still another illustrative example of use of the subject laminated construction tape is shown in FIG. 5. In this figure a roof 112 and gable junction 116 creates a possibility for water intrusion into a home along the seam which may or may not involve roof lines of unequal grade. This can be addressed by application of the subject laminated construction tape 130 directly onto the roof junction with a layer of conventional metal flashing 148 applied on top of the subject laminated construction tape 130.

### Laminated Construction Tape

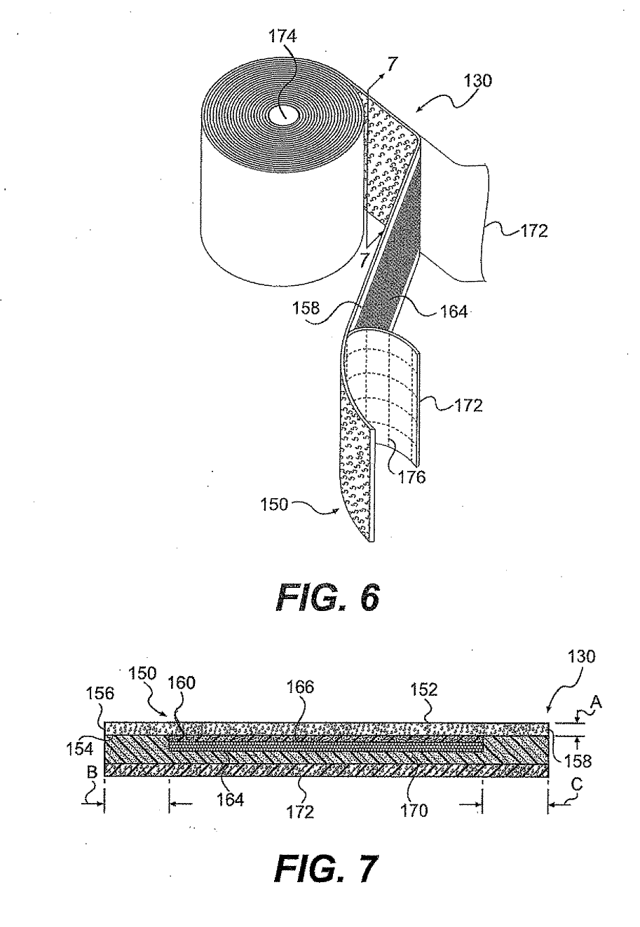

Turning specifically now to FIGS. 6 and 7 there will be seen detail views of a laminated constructed tape 130 in accordance with one specific embodiment of the invention. In this the construction tape 130 comprises a flexible, spun bonded polyester strip 150. Spun bonded material is structurally rugged in two dimensions and is flexible but highly resistant to tear. Moreover, spun bonded material is water repellant and exhibits good tensile strength.

The spun bonded polyester strip 150 has a first side 152 and a second side 154, a first edge 156 and a second edge 158. The thickness “A” of the spun bonded strip for most construction projects is approximately between 9.2 millimeters and 11.6 millimeters with a preferred thickness of approximately 10.4 millimeters. The spun bonded polyester strip as a preferred range of unit weight of approximately between 1.3 and 1.4 ounces per square yard and a preferred weight of approximately 1.35 ounces per square yard. In a preferred form the subject spun bonded material exhibits a sheet trapezoid tear strength of approximately 7.0 pounds.

A first layer of adhesive 160 is applied to the second side 154 of the spun bonded strip 150 along a central core region of the strip without extending to the edges 156 and 158 of the strip 150. In a preferred form the first layer of adhesive 160 is composed of water based ethylene vinyl acetate adhesive.

The equal lateral margins “B” and “C” that extend along the strip 150 can vary in width but in a preferred form comprise, in sum, between approximately twenty five percent (25%) and fifty percent (50%) of the width of the entire strip 150 with a preferred dimensional ratio being approximately thirty percent (30%). The total width of the laminated construction tape 130 can vary in accordance with the intended construction applications but the width is preferably four inches, six inches or eight inches in most applications but can be greater than a foot in some instances. In the preferred applications, however, the sum of the margins “B” and “C” in the most preferred form is approximately one point two inches for a four inch tape, one point eight and two point four inches respectively.

A central core layer “D” of reinforcing 164 comprising a band of substantially parallel polyester yarns 166 extend coextensively with the first layer of adhesive 160 along the center of the spun bonded polyester strip 150. In a preferred embodiment the substantially parallel polyester yarns have a denier of approximately 1513 grams per nine kilometers. The reinforcing provides structural integrity to the center region of the strip 150 and is held in position by the first layer of adhesive 160.

A second layer of pressure sensitive adhesive 170 overlays the margins “B”, and “C” of the spun bonded polyester strip 150 and across the core layer “D” of reinforcing polyester yarns 166. The pressure sensitive adhesive (PSA) is composed of an acrylic pressure sensitive transfer adhesive having a high shear strength (dynamic shear of 14.7 psi to 17.4 psi) and a low glass transition (tacky to solid) temperature “Tg” of approximately minus 30 degrees centigrade so that the laminated construction tape can be used in cold weather applications. One PSA that applicant has found suitable is VT 3600 or 3604 manufactured by the Venture Tape Corp. of Rockland, Mass. 02370.

As best seen in FIG. 7 the margin areas “B” and “C” of the pressure sensitive adhesive of the laminated construction tape are thicker than the center portion of the tape and in a preferred embodiment the margin areas are twice as thick as in the center of the tape to provide enhanced attachment acapacity to an underlying building surface.

Finally the laminated construction tape 130 is provided with an outer release strip 172 that over lays the second layer of self adhering construction adhesive 170. The release strip is composed of a high density polyethylene coated with a silicone release coating on the side adjacent to the second layer of adhesive 170. In this form the laminated construction tape 130 is suitable to be manufactured and stored on a spool 174 for storage and delivery to a job site.

The release strip includes in one embodiment an x-y pre-marked grid 176 to facilitate cutting and accurate application to a construction joint. In addition the release strip is selected to by easily marked with a conventional ball point pen or carpenter's pencil to facilitate cutting and shaping to fit construction junctions.

A method of application of the laminated construction tape of the subject invention includes unrolling a length of the tape to fit the particular construction purpose. Exact lengths can be measured and marked on either side of the tape. The tape 130 is then cut to length as measured and the release layer at one end is peeled away to permit initial application. As the laminated construction tape 130 is aligned and positioned for application the release layer can be pulled away permitting the second adhesive layer 170 to directly and firmly self adhere to the underlying construction junction. The relatively thicker edge margin areas “B” and “C” (approximately twice the thickness of a central region of the tape) provide secure adhesive contact with an underlying construction component which permits a degree of water tight sealed lateral and/or longitudinal movement while the central portion of the tape 130 provides dimensional stability for the flashing project.

In the preceding specification use of the terms first and second are expressions of differentiation and while first has been used with respect to a side surface of the laminated construction tape 130 there is no structural significance intended by this designation. In addition preferred thicknesses and weight of components have been express as approximately. In this, although the ranges and specific values are preferred it is intended that the scope of the disclosure and claims are not to be limited to exactly the stated ranges and values but would also include equivalent values for the recited functions.

The preceding description has been presented only to illustrate and describe the invention and some examples of its implementation. It is not intended to be exhaustive or to limit the invention to any precise form disclosed. Many modifications and variations are possible and would be envisioned by one of ordinary skill in the art in light of the above teaching.

The various aspects were chosen and described in order to best explain principles of the invention and its practical applications. The preceding description is intended to enable others skilled in the art to best utilize the invention in various embodiments and aspects and with various modifications as are suited to the particular use contemplated. It is intended that the scope of the invention be defined by the following claims; however, it is not intended that any order be presumed by the sequence of steps recited in the method claims unless a specific order is directly recited.

What is claimed is:

1. A laminated construction tape for uses as balcony flashing tape, flashing for roofing joints, foundation flashing, step flashing under siding, balcony and breezeway flashing, and the like, said laminated construction tape comprising:
a flexible, spun bonded polyester strip having a first side and a second side and a first longitudinally extending edge and a second longitudinally extending edge;
a first layer of adhesive longitudinally extending along and covering a central strip of said second side of said spun bonded, polyester strip;
a core layer of reinforcing comprising a band of substantially parallel polyester yarns extending longitudinally along said spun bonded, polyester strip,
said core layer of reinforcing being laterally spaced from said first and said second longitudinally extending edges of said spun bonded, polyester strip and overlying and coextensive with said first layer of adhesive, and
the lateral space by said core layer of reinforcing from the first and second longitudinal edges of said spun bonded polyester strip is substantially equal on each side and the sum of the spacing is approximately between twenty five percent and fifty percent of the width of said spun bonded polyester strip;
a second layer of adhesive coextensively covering said layer of reinforcing and in addition extending to each edge of said spun bonded, polyester strip to be coextensive with said spun bonded polyester strip; and
a release strip coextensively extending with and releasably adhered to said second layer adhesive, wherein upon removable of said release strip said laminated construction tape is operable to be applied as flashing for construction projects.

2. A laminated construction tape for uses as balcony flashing tape, flashing for roofing joints, foundation flashing, step flashing under siding, balcony and breezeway flashing, and the like, as defined in claim 1, wherein said flexible, spun bonded, polyester strip comprises:
a spun bonded polyester strip having a unit weight of approximately between 1.3 and 1.4 ounces per square yard.

3. A laminated construction tape for uses as balcony flashing tape, flashing for roofing joints, foundation flashing, step flashing under siding, balcony and breezeway flashing, and the like, as defined in claim 2, wherein:
said flexible, spun bonded polyester strip has a unit weight of approximately 1.35 ounces per square yard.

4. A laminated construction tape for uses as balcony flashing tape, flashing for roofing joints, foundation flashing, step flashing under siding, balcony and breezeway flashing, and the like, as defined in claim 1, wherein said flexible, spun bonded, polyester strip comprises:
a spun bonded polyester strip having a thickness of approximately between 9.2 and 11.6 millimeters.

5. A laminated construction tape for uses as balcony flashing tape, flashing for roofing joints, foundation flashing, step flashing under siding, balcony and breezeway flashing, and the like, as defined in claim 4, wherein:
said spun bonded polyester strip has a thickness of approximately 10.4 millimeter.

6. A laminated construction tape for use as balcony flashing tape, flashing for roofing joints, foundation flashing, step flashing under siding, balcony and breezeway flashing, and the like, as defined in claim 1, wherein said first layer of adhesive comprises:
a water based ethylene vinyl acetate adhesive.

7. A laminated construction tape for use as balcony flashing tape, flashing for roofing joints, foundation flashing, step flashing under siding, balcony and breezeway flashing, and the like, as defined in claim 1, wherein said layer of reinforcing comprises:
substantially parallel polyester yarns having a denier of approximately 1513 grams per nine kilometers.

8. A laminated construction tape for use as balcony flashing tape, flashing for roofing joints, foundation flashing, balcony and breezeway waterproofing, and the like, as defined in claim 1, wherein:
the lateral space by said layer of reinforcing from the first and second longitudinally edges of said spun bonded polyester strip is substantially equal on each side and the sum of the spacing is equal to approximately thirty percent of the width of said spun bonded polyester strip.

9. A laminated construction tape for use as balcony flashing tape, flashing for roofing joints, foundation flashing, balcony and breezeway waterproofing, and the like, as defined in claim 1, wherein said second layer of adhesive comprises:
an acrylic pressure sensitive transfer adhesive having a glass transition temperature Tg of approximately minus 30 degrees centigrade for low temperature application.

10. A laminated construction tape for use as balcony flashing tape, flashing for roofing joints, foundation flashing, balcony and breezeway waterproofing, and the like, as defined in claim 1, wherein said second layer of adhesive comprises:
a thickness along the lateral space along the edges of the laminated construction tape is approximately twice the thickness of the adhesive in the center of the tape.

11. A laminated construction tape for use as balcony flashing tape, flashing for roofing joints, foundation flashing, balcony and breezeway waterproofing, and the like, as defined in claim 10, wherein said release strip comprises:
high density polyethylene coated with a silicone release coating on the side adjacent said second layer of adhesive.

12. A laminated construction tape for use as balcony flashing tape, flashing for roofing joints, foundation flashing, balcony and breezeway waterproofing, and the like, as defined in claim 10, wherein:
the outer layer of said release strip includes orthogonal pre-marking for pattern cutting of said laminated construction tape before application and being said release strip being operable to receive ball point pen marking for pattern cutting of said laminated construction tape before application.

13. A laminated construction tape for uses as balcony flashing tape, flashing for roofing joints, foundation flashing, step flashing under siding, balcony and breezeway flashing, and the like, said laminated construction tape comprising:
a flexible, spun bonded polyester strip having a first side and a second side and a first longitudinally extending edge and a second longitudinally extending edge,
said flexible, spun bonded polyester strip having a unit weight of approximately between 1.3 and 1.4 ounces per square yard, and
said spun bonded polyester strip having a thickness of approximately between 9.2 and 11.6 millimeters;
a first layer of adhesive longitudinally extending along and covering a central strip of said second side of said spun bonded, polyester strip,
a core layer of reinforcing comprising a band of substantially parallel polyester yarns extending longitudinally along said spun bonded, polyester strip,
said core layer of reinforcing being laterally spaced from said first and said second longitudinally extending edges of said spun bonded, polyester strip and overlying and coextensive with said first layer of adhesive,
the lateral space by said core layer of reinforcing from the first and second longitudinal edges of said spun bonded polyester strip is substantially equal on each side and the sum of the spacing is approximately equal to thirty percent of the width of said spun bonded polyester strip.
a second layer of adhesive coextensively covering said layer of reinforcing and in addition extending to each edge of said spun bonded, polyester strip to be coextensive with said spun bonded polyester strip; and
a release strip coextensively extending with and releasably adhered to said second layer adhesive, wherein upon removable of said release strip said laminated construction tape is operable to be applied as flashing for construction projects.

14. A laminated construction tape for uses as balcony flashing tape, flashing for roofing joints, foundation flashing, step flashing under siding, balcony and breezeway flashing, and the like, as defined in claim 13, wherein:
said flexible, spun bonded polyester strip has a unit weight of approximately 1.35 ounces per square yard.

15. A laminated construction tape for uses as balcony flashing tape, flashing for roofing joints, foundation flashing, step flashing under siding, balcony and breezeway flashing, and the like, as defined in claim 13, wherein:
said spun bonded polyester strip has a thickness of approximately 10.4 millimeter.

16. A laminated construction tape for use as balcony flashing tape, flashing for roofing joints, foundation flashing, balcony and breezeway waterproofing, and the like, as defined in claim 13, wherein said release strip comprises:
a high density polyethylene coated with a silicone release coating on the side adjacent said second layer of adhesive.

17. A laminated construction tape for use as balcony flashing tape, flashing for roofing joints, foundation flashing, balcony and breezeway waterproofing, and the like, as defined in claim 1, wherein said second layer of adhesive comprises:
an acrylic pressure sensitive transfer adhesive having a low Tg factor operable for low temperature application.

18. A laminated construction tape for uses as balcony flashing tape, flashing for roofing joints, foundation flashing, step flashing under siding, balcony and breezeway flashing, and the like, said laminated construction tape comprising:
a flexible, spun bonded polyester strip having a first side and a second side and a first longitudinally extending edge and a second longitudinally extending edge,
said flexible, spun bonded polyester strip having a unit weight of approximately 1.35 ounces per square yard, and
said spun bonded polyester strip having a thickness of approximately 10.4 millimeters;
a first layer of adhesive longitudinally extending along and covering a central strip of said second side of said spun bonded, polyester strip,
a layer of reinforcing comprising a band of substantially parallel polyester yarns extending longitudinally along said spun bonded, polyester strip,
said layer of reinforcing being laterally spaced from said first and said second longitudinally extending edges of said spun bonded, polyester strip and overlying and coextensive with said first layer of adhesive, said lateral spacing being approximately equal on both sides of said spun bonded strip and being greater than approximately 25 percent of the width of said spun bonded strip and less than approximately fifty percent of the width of said spun bonded strip;
a second layer of adhesive coextensively covering said layer of reinforcing and in addition extending to each edge of said spun bonded, polyester strip to be coextensive with said spun bonded polyester strip; and
a release strip coextensively extending with and releasably adhered to said second layer adhesive, wherein upon removable of said release strip said laminated construction tape is operable to be applied as flashing for construction projects.

19. A laminated construction tape for use as balcony flashing tape, flashing for roofing joints, foundation flashing, step flashing under siding, balcony and breezeway flashing, and the like, as defined in claim 18, wherein said flexible spun bonded polyester strip comprises:
a spun bonded strip having a trapezoidal tear strength of approximately 7.0 pounds.

20. A laminated construction tape for use as balcony flashing tape, flashing for roofing joints, foundation flashing, step flashing under siding, balcony and breezeway flashing, and the like, as defined in claim 18, wherein said layer of reinforcing comprises:
substantially parallel polyester yarns having a denier of approximately 1513 grams per nine kilometers.

21. A laminated construction tape for use as balcony flashing tape, flashing for roofing joints, foundation flashing, balcony and breezeway waterproofing, and the like, as defined in claim 18, wherein said second layer of adhesive comprises:
an acrylic pressure sensitive transfer adhesive having a low Tg factor operable for low temperature application.

22. A laminated construction tape for use as balcony flashing tape, flashing for roofing joints, foundation flashing, balcony and breezeway waterproofing, and the like, as defined in claim 21, wherein:
the outer layer of said release strip being operable to receive ball point pen marking for pattern cutting of said laminated construction tape before application.
